(19) United States
(12) Patent Application Publication
(10) Pub. No.: US 2020/0377826 A1
(43) Pub. Date: Dec. 3, 2020

(54) LIQUID HAND DISHWASHING DETERGENT COMPOSITION

(71) Applicant: The Procter & Gamble Company, Cincinnati, OH (US)

(72) Inventors: Karl Ghislain BRAECKMAN, Gerpinnes (BE); Jeremie Robert Marcel GUMMEL, Brussels (BE); Robby Renilde Francois KEULEERS, Lippelo (BE); Christopher Hebden NUNN, Egham (GB); Pieter Jan Maria SAVEYN, (US); Jonathan Richard STONEHOUSE, Windlesham (GB); Mauro VACCARO, Brussels (BE)

(21) Appl. No.: 16/879,931

(22) Filed: May 21, 2020

(30) Foreign Application Priority Data
May 29, 2019 (EP) 19177150.0
Dec. 26, 2019 (EP) 19219720.0

(51) Int. Cl. C11D 3/37; C11D 3/00; C11D 1/94

(52) U.S. Cl. CPC C11D 3/3707; C11D 3/0094; C11D 1/146; C11D 3/3723; C11D 1/94

(57) ABSTRACT

The need for a liquid hand-dishwashing composition which provides further improved sudsing volume and longevity when washing dishware, especially at elevated temperatures, using diluted liquid hand dishwashing compositions, and especially in the presence of greasy soil and particulate soil, while avoiding unsightly residues on dishware, is met by combining a sudsing surfactant system with an EO-PO-EO triblock copolymer and an ethoxylated polyethyleneimine which does not comprise any further alkoxylations.

### FIELD OF THE INVENTION

The present invention relates to a liquid hand dishwashing detergent composition comprising a surfactant system, at least one EO-PO-EO triblock co-polymer, and an ethoxylated polyalkyleneimine.

### BACKGROUND OF THE INVENTION

Hand dishwashing detergent compositions should have good sudsing profile while providing good greasy soil cleaning. A lack of sudsing can lead the user to have the impression that the dish composition has become saturated with dirt and is no longer effective at cleaning, especially when used in full sink wash conditions. That is, when the liquid hand dishwashing detergent has been diluted in water in a sink or similar receptacle, in which the soiled dishes are washed.

As described in European applications 18207430.2, 18196142.6 and 17203791.3, improved sudsing profile can be achieved through the use of ethyleneoxide (EO)-propyleneoxide (PO)-ethyleneoxide (EO) triblock co-polymers. Such polymers have also been found to improve sudsing even in the presence of greasy soils. However, it has been found that when such liquid hand dishwashing detergents are diluted in relatively hot water to form a dishwashing liquor, an increase in detergent residues on the washed plates has been observed, resulting in unsightly residues and increased haziness of the dishes. Such residues and haziness can result in an impression that the dishes have not been sufficiently well cleaned.

Thus, a need remains for a hand dish washing detergent composition which provides a good sudsing profile, in particular enhanced suds volume and/or enhanced suds stabilization during full sink washing conditions, while also preventing unsightly residues or haziness on the washed dishes, regardless of the temperature at which the dishes have been washed.

European applications 17203791.3 relates to a hand dishwashing detergent composition including a surfactant system; at least one triblock co-polymer; and an amphiphilic alkoxylated polyalkyleneimine WO2007/135645A relates to a liquid detergent composition having alkoxylated polyethyleneimine polymer and alkyl or hydroxyalkyl sulphate or sulphonate surfactants to provide improved grease cleaning. U.S. Pat. No. 4,904,359A relates to high sudsing liquid detergent compositions containing anionic surfactant and polymeric surfactant which contains ether linkages, the anionic surfactant forming stable complexes with the polymeric surfactant for improved grease handling. EP2014753A relates to a stable liquid detergent composition having a pH comprised between 7.5 and 8.4 and comprising an alkyl ethoxy sulfate surfactant, an amine oxide surfactant and a polyethyleneimine polymer to provide improved grease cleaning and sudsing and to reduce solution slipperiness.

### SUMMARY OF THE INVENTION

The present invention relates to a liquid hand dishwashing cleaning composition comprising: from 5% to 50% by weight of the total composition of a surfactant system; and from 0.1% to 5.0% by weight of the total composition of at least one ethyleneoxide (EO)-propyleneoxide (PO)-ethyleneoxide (EO) triblock co-polymer of Formula (I):

(EO)x-(PO)y-(EO)x (I)

wherein: each x is independently on average between 3 and 50; and y is on average between 5 and 60; and from 0.05% to 2% by weight of the total composition of an ethoxylated polyalkyleneimine and mixtures thereof, wherein the ethoxylated polyalkyleneimine comprises no further alkoxylation and wherein the ethoxylated polyalkyleneimine comprises a polyethyleneimine backbone having a weight average molecular weight of less than 1500 g/mol.

The present invention further relates to method of manually washing dishware comprising the steps of: delivering a composition according to the invention to a volume of water to form a wash solution and immersing the dishware in the solution.

### DETAILED DESCRIPTION OF THE INVENTION

The compositions of the present invention provide improved sudsing volume and suds longevity when washing dishware in the diluted liquid hand dishwashing compositions, even in the presence of greasy soil and particulate soil, while also preventing unsightly residues or haziness on the washed dishes, regardless of the temperature at which the dishes have been washed.

As used herein, articles such as “a” and “an” when used in a claim, are understood to mean one or more of what is claimed or described.

The term “comprising” as used herein means that steps and ingredients other than those specifically mentioned can be added. This term encompasses the terms “consisting of” and “consisting essentially of.” The compositions of the present invention can comprise, consist of, and consist essentially of the essential elements and limitations of the invention described herein, as well as any of the additional or optional ingredients, components, steps, or limitations described herein.

The term “dishware” as used herein includes cookware and tableware made from, by non-limiting examples, ceramic, china, metal, glass, plastic (e.g., polyethylene, polypropylene, polystyrene, etc.) and wood.

The term “grease” or “greasy” as used herein means materials comprising at least in part (i.e., at least 0.5 wt % by weight of the grease) saturated and unsaturated fats and oils, preferably oils and fats derived from animal sources such as beef, pig and/or chicken.

The terms “include”, “includes” and “including” are meant to be non-limiting.

The term “particulate soils” as used herein means inorganic and especially organic, solid soil particles, especially food particles, such as for non-limiting examples: finely divided elemental carbon, baked grease particle, and meat particles.

The term “sudsing profile” as used herein refers to the properties of a cleaning composition relating to suds character during the dishwashing process. The term “sudsing profile” of a cleaning composition includes suds volume generated upon dissolving and agitation, typically manual agitation, of the cleaning composition in the aqueous washing solution, and the retention of the suds during the dishwashing process. Preferably, hand dishwashing cleaning compositions characterized as having “good sudsing profile” tend to have high suds volume and/or sustained suds volume, particularly during a substantial portion of or for the entire manual dishwashing process. This is important as the consumer uses high suds as an indicator that sufficient cleaning composition has been dosed. Moreover, the consumer also uses the sustained suds volume as an indicator that sufficient active cleaning ingredients (e.g., surfactants) are present, even towards the end of the dishwashing process. The consumer usually renews the washing solution when the sudsing subsides. Thus, a low sudsing cleaning composition will tend to be replaced by the consumer more frequently than is necessary because of the low sudsing level.

It is understood that the test methods that are disclosed in the Test Methods Section of the present application must be used to determine the respective values of the parameters of Applicants' inventions as described and claimed herein.

In all embodiments of the present invention, all percentages are by weight of the total composition, as evident by the context, unless specifically stated otherwise. All ratios are weight ratios, unless specifically stated otherwise, and all measurements are made at 25° C., unless otherwise designated.

### Cleaning Composition

The cleaning composition is a hand dishwashing cleaning composition in liquid form. The cleaning composition is preferably an aqueous cleaning composition. As such, the composition can comprise from 50% to 90%, preferably from 60% to 75%, by weight of the total composition of water.

Preferably, the pH of the composition is from about 6 to about 14, preferably from about 7 to about 12, or more preferably from about 7.5 to about 10, as measured at 10% dilution in distilled water at 20° C. The pH of the composition can be adjusted using pH modifying ingredients known in the art.

The composition of the present invention can be Newtonian or non-Newtonian, preferably Newtonian. Preferably, the composition has a viscosity of from 10 mPa·s to 10,000 mPa·s, preferably from 100 mPa·s to 5,000 mPa·s, more preferably from 300 mPa·s to 2,000 mPa·s, or most preferably from 500 mPa·s to 1,500 mPa·s, alternatively combinations thereof. The viscosity is measured at 20° C. with a Brookfield RT Viscometer using spindle 31 with the RPM of the viscometer adjusted to achieve a torque of between 40% and 60%.

### Surfactant System

The cleaning composition comprises from 5% to 50%, preferably 8% to 45%, more preferably from 15% to 40%, by weight of the total composition of a surfactant system.

For improved sudsing, the surfactant system comprises anionic surfactant. The surfactant system preferably comprises from 60% to 90% by weight of the surfactant system of the anionic surfactant. Alkyl sulphated anionic surfactants are preferred, particularly those selected from the group consisting of: alkyl sulphate, alkyl alkoxy sulphate, and mixtures thereof. More preferably, the anionic surfactant consists of alkyl sulphated anionic surfactant selected from the group consisting of: alkyl sulphate, alkyl alkoxy sulphate, and mixtures thereof.

For further improvements in sudsing, the surfactant system can comprise less than 30%, preferably less than 15%, more preferably less than 10% of further anionic surfactant, and most preferably the surfactant system comprises no further anionic surfactant. The alkyl sulphated anionic surfactant preferably has an average alkyl chain length of from 8 to 18, preferably from 10 to 14, more preferably from 12 to 14, most preferably from 12 to 13 carbon atoms. The alkyl sulphated anionic surfactant has an average degree of alkoxylation, of less than 5, preferably less than 3, more preferably from 0.5 to 2.0, most preferably from 0.5 to 0.9. Preferably, the alkyl sulphated anionic surfactant is ethoxylated. That is, the alkyl sulphated anionic surfactant has an average degree of ethoxylation, of less than 5, preferably less than 3, more preferably from 0.5 to 2.0, most preferably from 0.5 to 0.9.

The average degree of alkoxylation is the mol average degree of alkoxylation (i.e., mol average alkoxylation degree) of all the alkyl sulphate anionic surfactant. Hence, when calculating the mol average alkoxylation degree, the mols of non-alkoxylated sulphate anionic surfactant are included:

Mol average alkoxylation degree=(x1*alkoxylation degree of surfactant 1+x2*alkoxylation degree of surfactant 2+ . . . )/(x1+x2+ . . . )

wherein x1, x2, . . . are the number of moles of each alkyl (or alkoxy) sulphate anionic surfactant of the mixture and alkoxylation degree is the number of alkoxy groups in each alkyl sulphate anionic surfactant.

The alkyl sulphate anionic surfactant can have a weight average degree of branching of more than 10%, preferably more than 20%, more preferably more than 30%, even more preferably between 30% and 60%, most preferably between 30% and 50%. The alkyl sulphate anionic surfactant can comprise at least 5%, preferably at least 10%, most preferably at least 25%, by weight of the alkyl sulphate anionic surfactant, of branching on the C2 position (as measured counting carbon atoms from the sulphate group for non-alkoxylated alkyl sulphate anionic surfactants, and the counting from the alkoxy-group furthest from the sulphate group for alkoxylated alkyl sulphate anionic surfactants). More preferably, greater than 75%, even more preferably greater than 90%, by weight of the total branched alkyl content consists of C1-C5 alkyl moiety, preferably C1-C2 alkyl moiety. It has been found that formulating the inventive compositions using alkyl sulphate surfactants having the aforementioned degree of branching results in improved low temperature stability. Such compositions require less solvent in order to achieve good physical stability at low temperatures. As such, the compositions can comprise lower levels of organic solvent, of less than 5.0% by weight of the cleaning composition of organic solvent, while still having improved low temperature stability. Higher surfactant branching also provides faster initial suds generation, but typically less suds mileage. The weight average branching, described herein, has been found to provide improved low temperature stability, initial foam generation and suds longevity.

The weight average degree of branching for an anionic surfactant mixture can be calculated using the following formula:

Weight average degree of branching (%)=[(x1*wt % branched alcohol 1 in alcohol 1+x2*wt % branched alcohol 2 in alcohol 2+ . . . )/(x1+x2+ . . . )]*100

wherein x1, x2, . . . are the weight in grams of each alcohol in the total alcohol mixture of the alcohols which were used as starting material before (alkoxylation and) sulphation to produce the alkyl (alkoxy) sulphate anionic surfactant. In the weight average degree of branching calculation, the weight of the alkyl alcohol used to form the alkyl sulphate anionic surfactant which is not branched is included.

The weight average degree of branching and the distribution of branching can typically be obtained from the technical data sheet for the surfactant or constituent alkyl alcohol. Alternatively, the branching can also be determined through analytical methods known in the art, including capillary gas chromatography with flame ionisation detection on medium polar capillary column, using hexane as the solvent. The weight average degree of branching and the distribution of branching is based on the starting alcohol used to produce the alkyl sulphate anionic surfactant.

The alkyl chain of the alkyl sulphated anionic surfactant preferably has a mol fraction of C12 and C13 chains of at least 50%, preferably at least 65%, more preferably at least 80%, most preferably at least 90%. Suds mileage is particularly improved, especially in the presence of greasy soils, when the C13/C12 mol ratio of the alkyl chain is at least 50/50, preferably at least 57/43, preferably from 60/40 to 90/10, more preferably from 60/40 to 80/20, most preferably from 60/40 to 70/30, while not compromising suds mileage in the presence of particulate soils.

Suitable counterions include alkali metal cation earth alkali metal cation, alkanolammonium or ammonium or substituted ammonium, but preferably sodium.

Suitable examples of commercially available alkyl sulphate anionic surfactants include, those derived from alcohols sold under the Neodol® brand-name by Shell, or the Lial®, Isalchem®, and Safol® brand-names by Sasol, or some of the natural alcohols produced by The Procter & Gamble Chemicals company. The alcohols can be blended in order to achieve the desired mol fraction of C12 and C13 chains and the desired C13/C12 ratio, based on the relative fractions of C13 and C12 within the starting alcohols, as obtained from the technical data sheets from the suppliers or from analysis using methods known in the art.

In order to improve surfactant packing after dilution and hence improve suds mileage, the surfactant system comprises a co-surfactant. Preferred co-surfactants are selected from the group consisting of an amphoteric surfactant, a zwitterionic surfactant, and mixtures thereof. The co-surfactant is preferably an amphoteric surfactant, more preferably an amine oxide surfactant. The co-surfactant is included as part of the surfactant system.

The composition preferably comprises from 0.1% to 20%, more preferably from 0.5% to 15% and especially from 2% to 10% by weight of the cleaning composition of the co-surfactant. The surfactant system of the cleaning composition of the present invention preferably comprises from 10% to 40%, preferably from 15% to 35%, more preferably from 20% to 30%, by weight of the surfactant system of a co-surfactant. The anionic surfactant to the co-surfactant weight ratio can be from 1:1 to 8:1, preferably from 2:1 to 5:1, more preferably from 2.5:1 to 4:1.

As mentioned earlier, amine oxide surfactants are preferred for use as a co-surfactant. The amine oxide surfactant can be linear or branched, though linear are preferred. Suitable linear amine oxides are typically water-soluble, and characterized by the formula R1-N(R2)(R3) O wherein R1 is a C8-18 alkyl, and the R2 and R3 moieties are selected from the group consisting of C1-3 alkyl groups, C1-3 hydroxyalkyl groups, and mixtures thereof. For instance, R2 and R3 can be selected from the group consisting of: methyl, ethyl, propyl, isopropyl, 2-hydroxethyl, 2-hydroxypropyl and 3-hydroxypropyl, and mixtures thereof, though methyl is preferred for one or both of R2 and R3. The linear amine oxide surfactants in particular may include linear C10-C18 alkyl dimethyl amine oxides and linear C8-C12 alkoxy ethyl dihydroxy ethyl amine oxides.

Preferably, the amine oxide surfactant is selected from the group consisting of: alkyl dimethyl amine oxide, alkyl amido propyl dimethyl amine oxide, and mixtures thereof. Alkyl dimethyl amine oxides are preferred, such as C8-18 alkyl dimethyl amine oxides, or C10-16 alkyl dimethyl amine oxides (such as coco dimethyl amine oxide). Suitable alkyl dimethyl amine oxides include C10 alkyl dimethyl amine oxide surfactant, C10-12 alkyl dimethyl amine oxide surfactant, C12-C14 alkyl dimethyl amine oxide surfactant, and mixtures thereof. C12-C14 alkyl dimethyl amine oxide are particularly preferred.

Alternative suitable amine oxide surfactants include mid-branched amine oxide surfactants.

As used herein, “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 can be from 10 to 24 carbon atoms, preferably from 12 to 20, and more preferably from 10 to 16. The number of carbon atoms for the one alkyl moiety (n1) is preferably the same or similar to the number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least 50 wt %, more preferably at least 75 wt % to 100 wt % of the mid-branched amine oxides for use herein. The amine oxide further comprises two moieties, independently selected from a C1-3 alkyl, a C1-3 hydroxyalkyl group, or a polyethylene oxide group containing an average of from about 1 to about 3 ethylene oxide groups. Preferably, the two moieties are selected from a C1-3 alkyl, more preferably both are selected as C1 alkyl.

Alternatively, the amine oxide surfactant can be a mixture of amine oxides comprising a mixture of low-cut amine oxide and mid-cut amine oxide. The amine oxide of the composition of the invention can then comprises:
a) from about 10% to about 45% by weight of the amine oxide of low-cut amine oxide of formula R1R2R3AO wherein R1 and R2 are independently selected from hydrogen, C1-C4 alkyls or mixtures thereof, and R3 is selected from C10 alkyls and mixtures thereof; and
b) from 55% to 90% by weight of the amine oxide of mid-cut amine oxide of formula R4R5R6AO wherein R4 and R5 are independently selected from hydrogen, C1-C4 alkyls or mixtures thereof, and R6 is selected from C12-C16 alkyls or mixtures thereof

In a preferred low-cut amine oxide for use herein R3 is n-decyl, with preferably both R1 and R2 being methyl. In the mid-cut amine oxide of formula R4R5R6A0, R4 and R5 are preferably both methyl.

Preferably, the amine oxide comprises less than about 5%, more preferably less than 3%, by weight of the amine oxide of an amine oxide of formula R7R8R9AO wherein R7 and R8 are selected from hydrogen, C1-C4 alkyls and mixtures thereof and wherein R9 is selected from C8 alkyls and mixtures thereof. Limiting the amount of amine oxides of formula R7R8R9AO improves both physical stability and suds mileage.

Suitable zwitterionic surfactants include betaine surfactants. Such betaine surfactants includes alkyl betaines, alkylamidobetaine, amidazoliniumbetaine, sulphobetaine (INCI Sultaines) as well as the Phosphobetaine, and preferably meets formula (II):

R¹—[CO—X(CH₂)ₙ]ₓ—N⁺(R²)(R₃)—(CH₂)ₘ—[CH(OH)—CH₂]_{y}—Y⁻

wherein in formula (II),

R1 is selected from the group consisting of: a saturated or unsaturated C6-22 alkyl residue, preferably C8-18 alkyl residue, more preferably a saturated C10-16 alkyl residue, most preferably a saturated C12-14 alkyl residue;

X is selected from the group consisting of: NH, NR4 wherein R4 is a C1-4 alkyl residue, O, and S,

n is an integer from 1 to 10, preferably 2 to 5, more preferably 3,

x is 0 or 1, preferably 1,

R2 and R3 are independently selected from the group consisting of: a C1-4 alkyl residue, hydroxy substituted such as a hydroxyethyl, and mixtures thereof, preferably both R2 and R3 are methyl,

m is an integer from 1 to 4, preferably 1, 2 or 3,

y is 0 or 1, and

Y is selected from the group consisting of: COO, SO3, OPO(OR5)O or P(O)(OR5)O, wherein R5 is H or a C1-4 alkyl residue.

Preferred betaines are the alkyl betaines of formula (Ia), the alkyl amido propyl betaine of formula (Ib), the sulphobetaines of formula (Ic) and the amido sulphobetaine of formula (Id):

R¹—N(CH₃)₂—CH₂COO⁻ (Ia)

R¹—CO—NH(CH₂)₃—N⁺(CH₃)—CH₂COO⁻ (Ib)

R¹—N⁺(CH₃)₂—CH₂CH(OH)CH₂SO₃— (Ic)

R¹—CO—NH—(CH₂)₃—N⁺(CH₃)₂—CH₂CH(OH)CH₂SO₃— (Id)

in which R1 has the same meaning as in formula (II). Particularly preferred are the carbobetaines [i.e. wherein Y—═COO— in formula (II)] of formulae (Ia) and (Ib), more preferred are the alkylamidobetaine of formula (Ib).

Suitable betaines can be selected from the group consisting or [designated in accordance with INCI]: capryl/capramidopropyl betaine, cetyl betaine, cetyl amidopropyl betaine, cocamidoethyl betaine, cocamidopropyl betaine, cocobetaines, decyl betaine, decyl amidopropyl betaine, hydrogenated tallow betaine/amidopropyl betaine, isostearamidopropyl betaine, lauramidopropyl betaine, lauryl betaine, myristyl amidopropyl betaine, myristyl betaine, oleamidopropyl betaine, oleyl betaine, palmamidopropyl betaine, palmitamidopropyl betaine, palm-kemelamidopropyl betaine, stearamidopropyl betaine, stearyl betaine, tallowamidopropyl betaine, tallow betaine, undecylenamidopropyl betaine, undecyl betaine, and mixtures thereof. Preferred betaines are selected from the group consisting of: cocamidopropyl betaine, cocobetaines, lauramidopropyl betaine, lauryl betaine, myristyl amidopropyl betaine, myristyl betaine, and mixtures thereof. Cocamidopropyl betaine is particularly preferred.

Preferably, the surfactant system of the composition of the present invention further comprises from 1% to 25%, preferably from 1.25% to 20%, more preferably from 1.5% to 15%, most preferably from 1.5% to 5%, by weight of the surfactant system, of a non-ionic surfactant.

Suitable nonionic surfactants can be selected from the group consisting of: alkoxylated non-ionic surfactant, alkyl polyglucoside (“APG”) surfactant, and mixtures thereof.

Suitable alkoxylated non-ionic surfactants can be linear or branched, primary or secondary alkyl alkoxylated non-ionic surfactants. Alkyl ethoxylated non-ionic surfactant are preferred. The ethoxylated non-ionic surfactant can comprise on average from 9 to 15, preferably from 10 to 14 carbon atoms in its alkyl chain and on average from 5 to 12, preferably from 6 to 10, most preferably from 7 to 8, units of ethylene oxide per mole of alcohol. Such alkyl ethoxylated nonionic surfactants can be derived from synthetic alcohols, such as OXO-alcohols and Fisher Tropsh alcohols, or from naturally derived alcohols, or from mixtures thereof. Suitable examples of commercially available alkyl ethoxylate nonionic surfactants include, those derived from synthetic alcohols sold under the Neodol® brand-name by Shell, or the Lial®, Isalchem®, and Safol® brand-names by Sasol, or some of the natural alcohols produced by The Procter & Gamble Chemicals company.

The compositions of the present invention can comprise alkyl polyglucoside (“APG”) surfactant. The addition of alkyl polyglucoside surfactants have been found to improve sudsing beyond that of comparative nonionic surfactants such as alkyl ethoxylated surfactants. Preferably the alkyl polyglucoside surfactant is a C8-C16 alkyl polyglucoside surfactant, preferably a C8-C14 alkyl polyglucoside surfactant. The alkyl polyglucoside preferably has an average degree of polymerization of between 0.1 and 3, more preferably between 0.5 and 2.5, even more preferably between 1 and 2. Most preferably, the alkyl polyglucoside surfactant has an average alkyl carbon chain length between 10 and 16, preferably between 10 and 14, most preferably between 12 and 14, with an average degree of polymerization of between 0.5 and 2.5 preferably between 1 and 2, most preferably between 1.2 and 1.6. C8-C16 alkyl polyglucosides are commercially available from several suppliers (e.g., Simusol® surfactants from Seppic Corporation; and Glucopon® 600 CSUP, Glucopon® 650 EC, Glucopon® 600 CSUP/MB, and Glucopon® 650 EC/MB, from BASF Corporation).

### Triblock Co-Polymer

The tri-block copolymers according to the invention are preferably present in the composition at a level of from 0.1% to 5%, preferably from 0.25% to 3.0%, more preferably from 0.5% to 2.0%, by weight of the total composition.

The triblock copolymer of the present invention is defined as a triblock co-polymer having alkylene oxide moieties according to Formula (I): (EO)x(PO)y(EO)x, wherein EO represents ethylene oxide, and each x represents the number of EO units within the EO block. Each x is independently a number average between 3 and 50, preferably between 5 and 25, more preferably between 10 and 15. Preferably x is the same for both EO blocks, wherein the “same” means that the x between the two EO blocks varies within a maximum 2 units, preferably within a maximum of 1 unit, more preferably both x's are the same number of units. PO represents propylene oxide, and y represents the number of PO units in the PO block. Each y is a number average between 5 and 60, preferably between 10 and 40, more preferably between 25 and 35.

The triblock co-polymer can have a ratio of y to each x of from 0.8:1 to 5:1, preferably from 1:1 to 3:1, more preferably from 1.5:1 to 2.5:1. The triblock co-polymer can have an average weight percentage of total EO of between 30% and 50% by weight of the triblock co-polymer. As such, the triblock co-polymer can have an average weight percentage of total PO of between 50% and 70% by weight of the triblock copolymer. It is understood that the average total weight % of EO and PO for the triblock co-polymer adds up to 100%, excluding the end-caps. The end-caps are preferably hydrogen, hydroxyl, methyl, and mixtures thereof, more preferably hydrogen, methyl, and mixtures thereof, and most preferably hydrogen. The triblock co-polymer has a number average molecular weight of between 550 and 8000, preferably between 1000 and 4500, more preferably between 2000 and 3100. Number average molecular weight and compositional analysis of the co-polymer is determined using a 1H NMR spectroscopy (see Thermo scientific application note No. AN52907). It is an established tool for polymer characterization, including number-average molecular weight determination and co-polymer composition analysis.

“Block copolymers” as used herein is meant to encompass co-polymers including two or more different homopolymeric and/or monomeric units, i.e., “building blocks”, which are linked to form a single polymer molecule. In this case, the block co-polymers are in the form of tri-block co-polymers. Triblock co-polymers have the basic structure ABA, wherein A and B are different homopolymeric and/or monomeric units. In this case A is ethylene oxide (EO) and B is propylene oxide (PO). Those skilled in the art will recognize the phrase “block co-polymers” is synonymous with this definition of “block polymers”.

“Building Blocks” herein is meant homopolymeric units and/or monomeric units that polymerize with one another to form block co-polymers. Suitable building blocks in accordance with the present invention are alkylene oxide moieties, more particularly ethylene oxide and propylene oxide moieties. The different homopolymeric units present in block co-polymers retain some of their respective individual, original properties even though they are linked to one or more different homopolymeric units. Block co-polymers are known to exhibit properties that are different from those of homopolymers, random co-polymers, and polymer blends. The properties of block co-polymers themselves also differ depending on the length and chemical composition of the blocks making up the block co-polymer. Accordingly, the properties of a block co-polymer are influenced by the arrangement of the blocks within the block polymer. For example, a polymer such as: hydrophobic block-hydrophilic block-hydrophobic block will exhibit properties that are different than a block polymer such as: hydrophilic block-hydrophobic block-hydrophilic block. Applicant has now surprisingly found that a triblock co-polymer according to Formula (I) with the specific EO/PO/EO arrangement and respective homopolymeric lengths enhances, when co-formulated with an ethoxylated polyethyleneimine, suds mileage performance of a hand dishwashing liquid composition in presence of greasy soils and/or suds consistency through dilution throughout the wash process while preventing unsightly residues on dishware especially when washing at elevated temperatures. Although not wishing to be bound by theory, it is believed that these triblock co-polymers provide the right hydrophilic hydrophobic balance to position themselves at the grease-water and especially at the air-water interface. The hydrophobic PO block can nicely pack itself along the grease and especially air surface while the dual hydrophilic end tails can reach out to the water phase as such stabilizing the grease in water emulsion and especially the air in water suspension, e.g., suds, accordingly. It is believed that at elevated temperatures, the cloud point of the triblock copolymer is approached, leading to dehydration of the triblock copolymer, greater phase instability, and higher deposition of the triblock copolymer onto dishes. As a result, unsightly residues or haziness is observed on the washed dishes. Complexation of the triblock copolymer with the highly ethoxylated polyethyleneimines is thought to inhibit this from happening.

EO-PO-EO triblock co-polymers are commercially available from BASF such as the Pluronic® PE series, and from the Dow Chemical Company such as Tergitol™ L series. Particularly preferred triblock co-polymer from BASF are sold under the tradenames Pluronic® L44 (MW ca 2200, ca 40 wt % EO), Pluronic® PE6400 (MW ca 2900, ca 40 wt % EO), Pluronic®

PE4300 (MW ca 1600, ca 30 wt % EO), and Pluronic® PE 9400 (MW ca 4600, 40 wt % EO). Particularly preferred triblock co-polymer from the Dow Chemical Company is sold under the tradename of Tergitol™ L64 (MW ca 2700, ca 40 wt % EO).

The preparation method for such triblock co-polymers is well known to polymer manufacturers and is not the subject of the present invention.

### Ethoxylated Polyalkyleneimine

The liquid hand dishwashing composition comprises from 0.01% to 5.0%, preferably from 0.05% to 2.5%, more preferably from 0.1% to 1.0% by weight of the liquid detergent composition of an ethoxylated polyalkyleneimine, wherein the ethoxylated polyalkyleneimine comprises no further alkoxylation. That is, the ethoxylated polyalkyleneimine comprises no further alkoxylation such as propoxylation or butoxylation. Preferred ethoxylated polyalkyleneimines consist of alkyleneimine monomer units and ethoxylation (-EO-) monomer units, with the exception of any end-caps, which are typically hydrogen. Ethyleneimine monomer units are highly preferred alkyleneimine monomer units.

The ethoxylated polyalkyleneimine has a weight average molecular weight of less than 1500 g/mol, preferably from 200 g/mol and 1500 g/mol, more preferably from 300 g/mol and 1000 g/mol, and most preferably from 500 g/mol and 700 g/mol, with about 600 g/mol being particularly preferred. When the ethoxylated polyethyleneimine has a polyethyleneimine backbone of higher molecular weight, it is believed that the resultant ethoxylated polyethyleneimine is not sufficiently hydrophilic and too bulky and hence less effective at increasing the cloud point of the composition comprising the triblock copolymer.

The ethoxylation chains within the ethoxylated polyalkyleneimine may be from 200 g/mol to 2000 g/mol weight average molecular weight, preferably from 400 g/mol to 1500 g/mol weight average molecular weight, more preferably from 600 g/mol to 1000 g/mol weight average molecular weight, most preferably about 880 g/mol weight average molecular weight per ethoxylated chain.

The ethoxylation chains within the ethoxylated polyalkyleneimine polymer of the present composition can have on average 5 to 40, preferably 10 to 30, more preferably 15 to 25, even more preferably 18 to 22, most preferably about 20 ethoxy units per ethoxylation chain.

The ethoxylated polyalkyleneimine may have a total weight average molecular weight of from 5000 g/mol to 20000 g/mol, preferably from 7500 g/mol to 17500 g/mol, more preferably from 10000 g/mol to 15000 g/mol, even more preferably from 12000 g/mol to 13000 g/mol, most preferably about 12700 g/mol.

The ethoxylation of the polyalkyleneimine backbone preferably includes: (1) one or two ethoxylation modifications per nitrogen atom, dependent on whether the modification occurs at a internal nitrogen atom or at a terminal nitrogen atom, in the polyalkyleneimine backbone, the ethoxylation modification consisting of the replacement of a hydrogen atom by a polyethoxylene chain having an average of about 5 to about 40 ethoxy moieties per modification, wherein the terminal alkoxy moiety of the alkoxylation modification is capped with hydrogen, a C₁-C₄ alkyl or mixtures thereof, preferably hydrogen; or (2) an addition of one C₁-C₄ alkyl moiety and one or two ethoxylation modifications per nitrogen atom, dependent on whether the substitution occurs at an internal nitrogen atom or at an terminal nitrogen atom, in the polyalkyleneimine backbone, the ethoxylation modification consisting of the replacement of a hydrogen atom by a polyethoxylene chain having an average of about 5 to about 40 ethoxy moieties per modification wherein the terminal ethoxy moiety is capped with hydrogen, a C₁-C₄ alkyl or mixtures thereof, preferably hydrogen; or (3) a combination thereof.

The polyalkyleneimine backbone is preferably polyethyleneimine

For example, but not limited to, below is shown possible modifications to terminal nitrogen atoms in the polyethyleneimine backbone where R represents an ethylene spacer and E represents a C₁-C₄ alkyl moiety and X⁻ represents a suitable water soluble counterion.

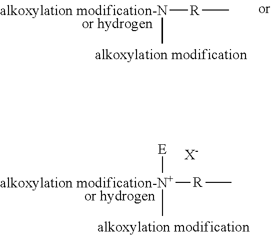

Also, for example, but not limited to, below is shown possible modifications to internal nitrogen atoms in the polyethyleneimine backbone where R represents an ethylene spacer and E represents a C₁-C₄ alkyl moiety and X— represents a suitable water soluble counterion.

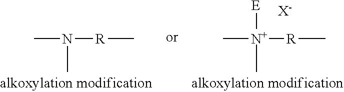

The modification may result in permanent quaternization of the polyethyleneimine backbone nitrogen atoms. The degree of permanent quaternization may be from 0% to about 30% of the polyethyleneimine backbone nitrogen atoms. It is preferred to have less than 30% of the polyethyleneimine backbone nitrogen atoms permanently quaternized. Most preferably the degree of quaternization is 0%.

A preferred ethoxylated polyalkyleneimine is an ethoxylated polyethyleneimine having the general structure of formula (III):

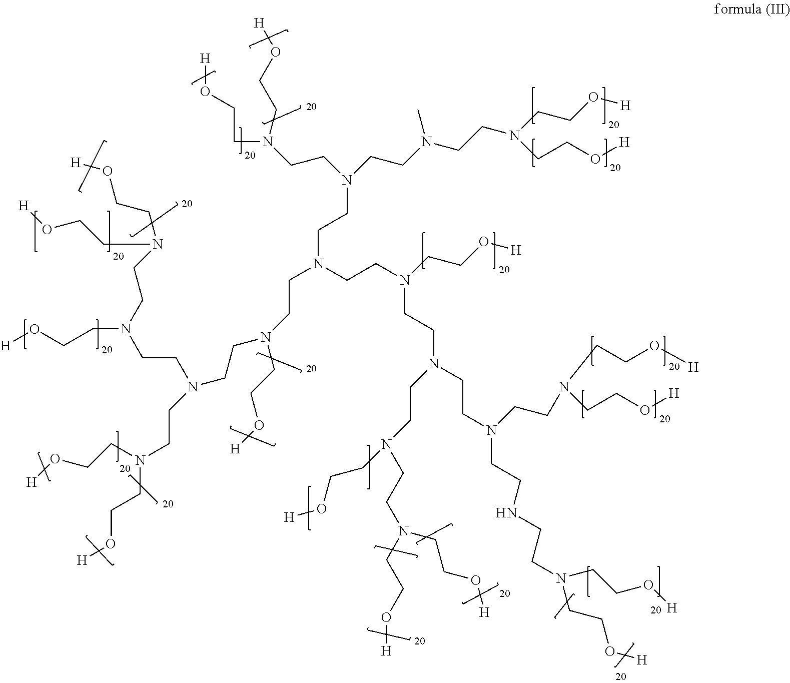

wherein the polyethyleneimine backbone has a weight average molecular weight of about 600 g/mol, n of formula (I) has an average of about 20. Each polyethoxy chain is hydrogen capped. The degree of permanent quaternization of formula (I) is 0% of the polyethyleneimine backbone nitrogen atoms. The molecular weight of this polyethyleneimine preferably is between 10000 and 15000 g/mol, more preferably about 12700 g/mol.

The ethoxylated polyalkyleneimine comprises, preferably consists of: a polyethyleneimine backbone having a weight average molecular weight of between 200 g/mol and 1500 g/mol, preferably between 300 g/mol and 1000 g/mol, most preferably between 500 g/mol and 700 g/mol; an average of 5 to 40, preferably 10 to 30, most preferably 18 to 22 ethoxy units per ethoxylation chain; the ethoxylated polyethyleneimine has a total weight average molecular weight of from about 5000 g/mol to about 20000 g/mol, preferably from about 7500 g/mol to about 17500 g/mol, most preferably from about 12000 g/mol to about 13000 g/mol; wherein the terminal ethoxy moiety of the ethoxylation modification is capped with hydrogen, a C₁-C₄ alkyl or mixtures thereof, preferably hydrogen or methyl or mixtures thereof, more preferably hydrogen; and the degree of permanent quaternization being from about 0% to about 30% of the polyethyleneimine backbone nitrogen atoms, preferably 0% to 10%, more preferably 0%, wherein the ethoxylated polyethyleneimine does not comprise any other alkoxylations other than ethoxylation.

The described ethoxylated polyalkyleneimines can be made using techniques previously described in the art, and as such those skilled in the art would understand how to produce such compounds. These polyethyleneimines can be prepared, for example, by polymerizing ethyleneimine in the presence of a catalyst such as carbon dioxide, sodium bisulfite, sulfuric acid, hydrogen peroxide, hydrochloric acid, acetic acid, and the like, followed by an ethoxylations step.

Cyclic Polyamine

The composition can comprise a cyclic polyamine having amine functionalities that helps cleaning. The composition of the invention preferably comprises from about 0.1% to about 3%, more preferably from about 0.2% to about 2%, and especially from about 0.5% to about 1%, by weight of the composition, of the cyclic polyamine

The amine can be subjected to protonation depending on the pH of the cleaning medium in which it is used. Preferred cyclic polyamines have the following Formula (IV):

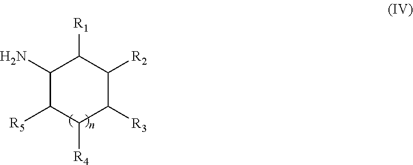

wherein R₁, R₂, R₃, R₄ and R₅ are independently selected from the group consisting of NH2, —H, linear or branched alkyl having from about 1 to about 10 carbon atoms, and linear or branched alkenyl having from about 1 to about 10 carbon atoms, n is from about 1 to about 3, preferably n is 1, and wherein at least one of the Rs is NH2 and the remaining “Rs” are independently selected from the group consisting of NH2, —H, linear or branched alkyl having about 1 to about 10 carbon atoms, and linear or branched alkenyl having from about 1 to about 10 carbon atoms. Preferably, the cyclic polyamine is a diamine, wherein n is 1, R₂ is NH2, and at least one of R₁, R₃, R₄ and R₅ is CH3 and the remaining Rs are H.

The cyclic polyamine has at least two primary amine functionalities. The primary amines can be in any position in the cyclic amine but it has been found that in terms of grease cleaning, better performance is obtained when the primary amines are in positions 1,3. It has also been found that cyclic amines in which one of the substituents is —CH3 and the rest are H provided for improved grease cleaning performance

Accordingly, the most preferred cyclic polyamine for use with the cleaning composition of the present invention are cyclic polyamine selected from the group consisting of: 2-methylcyclohexane-1,3-diamine, 4-methylcyclohexane-1,3-diamine and mixtures thereof. These specific cyclic polyamines work to improve suds and grease cleaning profile through-out the dishwashing process when formulated together with the surfactant system of the composition of the present invention.

### Additional Ingredients:

The composition of the present invention may further comprise at least one active selected from the group consisting of: i) a salt, ii) a hydrotrope, iii) an organic solvent, and mixtures thereof.

### Salt:

The composition of the present invention may comprise from about 0.05% to about 2%, preferably from about 0.1% to about 1.5%, or more preferably from about 0.5% to about 1%, by weight of the total composition of a salt, preferably a monovalent or divalent inorganic salt, or a mixture thereof, more preferably selected from: sodium chloride, sodium sulphate, and mixtures thereof. Sodium chloride is most preferred.

### Hydrotrope:

The composition of the present invention may comprise from about 0.1% to about 10%, or preferably from about 0.5% to about 10%, or more preferably from about 1% to about 10% by weight of the total composition of a hydrotrope or a mixture thereof, preferably sodium cumene sulphonate.

### Organic Solvent:

The composition can comprise from about 0.1% to about 10%, or preferably from about 0.5% to about 10%, or more preferably from about 1% to about 10% by weight of the total composition of an organic solvent. Suitable organic solvents include organic solvents selected from the group consisting of: alcohols, glycols, glycol ethers, and mixtures thereof, preferably alcohols, glycols, and mixtures thereof. Ethanol is the preferred alcohol. Polyalkyleneglycols, especially polypropyleneglycol, is the preferred glycol.

### Adjunct Ingredients

The cleaning composition may optionally comprise a number of other adjunct ingredients such as builders (preferably citrate), chelants, conditioning polymers, other cleaning polymers, surface modifying polymers, structurants (such as hydrogenated castor oil or microfibrous cellulose), emollients, humectants, skin rejuvenating actives, enzymes, carboxylic acids, scrubbing particles, perfumes, malodor control agents, pigments, dyes, opacifiers, pearlescent particles, inorganic cations such as alkaline earth metals such as Ca/Mg-ions, antibacterial agents, preservatives, viscosity adjusters (e.g., salt such as NaCl, and other mono-, di- and trivalent salts) and pH adjusters and buffering means (e.g. carboxylic acids such as citric acid, HCl, NaOH, KOH, alkanolamines, carbonates such as sodium carbonates, bicarbonates, sesquicarbonates, and alike).

### Method of Washing

The invention is further directed to a method of manually washing dishware with the composition of the present invention. The method comprises the steps of delivering a composition of the present invention to a volume of water to form a wash solution and immersing the dishware in the solution. The wash solution is preferably at a temperature of greater than 30° C., more preferably greater than 35° C., most preferably greater than 40° C. The wash solution is typically at a temperature of less than 70° C., more typically less than 60° C. The dishware is to be cleaned with the composition in the presence of water. Optionally, the dishware can be rinsed. By “rinsing”, it is meant herein contacting the dishware cleaned with the process according to the present invention with substantial quantities of appropriate solvent, typically water. By “substantial quantities”, it is meant usually about 1 to about 20 L, or under running water.

The composition herein can be applied in its diluted form. Soiled dishware is contacted with an effective amount, typically from about 0.5 mL to about 20 mL (per about 25 dishes being treated), preferably from about 3 mL to about 10 mL, of the cleaning composition, preferably in liquid form, of the present invention diluted in water. The actual amount of cleaning composition used will be based on the judgment of the user and will typically depend upon factors such as the particular product formulation of the cleaning composition, including the concentration of active ingredients in the cleaning composition, the number of soiled dishes to be cleaned, the degree of soiling on the dishes, and the like. Generally, from about 0.01 mL to about 150 mL, preferably from about 3 mL to about 40 mL of a cleaning composition of the invention is combined with from about 2,000 mL to about 20,000 mL, more typically from about 5,000 mL to about 15,000 mL of water in a sink. The soiled dishware are immersed in the sink containing the diluted cleaning compositions then obtained, before contacting the soiled surface of the dishware with a cloth, sponge, or similar cleaning implement. The cloth, sponge, or similar cleaning implement may be immersed in the cleaning composition and water mixture prior to being contacted with the dishware, and is typically contacted with the dishware for a period of time ranged from about 1 to about 10 seconds, although the actual time will vary with each application and user. The contacting of cloth, sponge, or similar cleaning implement to the dishware is accompanied by a concurrent scrubbing of the dishware.

### Examples

The hand dishwashing compositions, inventive Example 1 and comparative example A, were prepared by simple mixing:

| | Example 1 | Example A |
|---|---|---|
| | (Inventive) | (Comparative) |
| | wt % | wt % |
| NaCl | 0.5 | 0.5 |
| Sodium formate | 0.49 | 0.49 |
| Polypropyleneglycol (MW 2000) | 0.5 | 0.5 |
| Ethanol | 2 | 2 |
| C₁₂₋₁₃ AE_{0.6}S anionic surfactant | 22.6 | 22.6 |
| Methylcyclohexane-1,3-diamine¹ | 0.1 | 0.1 |
| C₁₂₋₁₄ dimethyl amine oxide | 6.11 | 6.11 |
| NaOH | 0.14 | 0.14 |
| EO-PO-EO copolymer of formula (I)² | 1.0 | 1.0 |
| Ethoxylated polyethyleneimine³ | 0.5 | — |
| Water + minors (preservative, dye, | to 100% | to 100% |
| perfume) | | |

¹Cyclic diamine mixture of 4-methylcyclohexane-1,3-diamine and 2-methylcyclohexane-1,3-diamine, supplied under the tradename Baxxodur ECX210 by BASF
²EO₁₃-PO₃₀-EO₁₃, Tergitol ® L64, supplied by DOW
³600 g/mol weight average molecular weight polyethylenimine substituted with 20 ethoxylate groups per —NH, with a total molecular weight of about 12700 g/mol, supplied by BASF

The compositions were diluted in a 25:75 ratio using water having a water hardness of 1.39 mmol/1 Ca/Mg ions (7.8° D) and the following methodology was used to determine the diffusion coefficient, measured at 55° C. and expressed in m²/s for the triblock copolymer, based on a monomodal fit of the echo decay of the methyl group in the PO units of the block copolymer.
Diffusion NMR (often referred to as Diffusion Ordered SpectroscopY-DOSY) was used since it is able to resolve different compounds spectroscopically in a mixture based on their differing diffusion coefficients, depending on the size and shape of the molecules. As such, diffusion NMR can be used to resolve otherwise intractable spectra of mixtures. For the measurements, a Bruker Avance III 400 MHz NMR spectrometer equipped with a Prodigy z-gradient cryoprobe was used, using the Bruker “Dynamics Center” software version 2.5.5.
The Pulsed Gradient STimulated Echo (PGSTE) methodology was used instead of the Pulsed-field Gradient Spin Echo (PGSE), since the dependence of the PGSE sequence on the transversal relaxation (T2) precludes its application to systems with broad line widths such as found with polymers studied at relatively low temperature. The standard Bruker pulse sequence ledbpgppr2s, which is the Wu (1995) sequence—a Bipolar Pulse Pair STimulated Echo (BPPSTE) sequence, with pre-saturation during the relaxation delay, the time for diffusion and the LED delay, was used. The BPPSTE sequence with pre-saturation of the water signal was used for the diffusion measurements to reduce the effect of inhomogeneous background gradients (see D. Wu, A. Chen, C. S. Johnson Jr., “An improved diffusion-ordered spectroscopy experiment incorporating bipolar-gradient pulses”, J. Magn. Reson. A 115 (1995) 260-264) and the insertion of a supplementary delay at the end attenuated the longitudinal eddy current effects (LED). The stimulated echo with bipolar pulse pair was used to dephase the nuclear magnetization and rephase it after the diffusion encoding delay. The length of these gradient pulses were 3 ms. The 7c/2 pulses after the bipolar gradients transferred magnetization on the z-axis, thus reducing T2 relaxation, and allowing spoiler gradients of 600 μs to be applied. A LED delay of 5 ms was used to allow eddy currents from the gradients to subside. A diffusion period of 100 ms was used.
2D-DOSY spectra were obtained by incrementing the gradient strengths on a series of 1D experiments and by fitting the experimental signal attenuation to the Stejskal-Tanner equation, as is known by people skilled in the art. 16 linearly-spaced gradient values were used ranging from 5%-95% of 10 A current from a GREAT 3/10 amplifier, with a resulting gradient strength of 5 Gauss/cm/A.
The following molar average diffusion coefficients, measured at 55° C. and expressed in m²/s for the triblock copolymer, based on a monomodal fit of the echo decay of the methyl group in the PO units of the copolymer, and as calculated using the Bruker “Dynamics Center” software version 2.5.5, were measured:

| | Example 1 | Example A |
|---|---|---|
| | (Inventive) | (Comparative) |
| Molar average diffusion | 9.6e⁻¹¹ | 8.7e⁻¹¹ |
| coefficient (m²/s) at 55° C. | | |

The addition of the ethoxylated polyethyleneimine resulted in a 10% improvement in the diffusivity coefficient for the EO-PO-EO triblock copolymer. The faster diffusion coefficient indicates not only that there was an interaction between the triblock copolymer and the ethoxylated polyethyleneimine, but also that the ethoxylated polyethyleneimine reduced the dehydration of the triblock copolymer and improved the phase stability of the triblock copolymer in wash solutions at elevated temperatures. By comparing with consumer test results, the 10% improvement in diffusivity has been found to correlate with a noticeable reduction in residues on the treated dish surface.
The following examples are provided to further illustrate the present invention:

| | Ex 2 | Ex 3 | Ex 4 | Ex 5 | Ex 6 |
|---|---|---|---|---|---|
| As 100% active | wt % | wt % | wt % | wt % | wt % |
| C1213AE0.6S | 20.4% | 15.0% | 20.4% | 20.4% | 15.0% |
| (Avg. branching: 33%) | | | | | |
| C₁₂₋₁₄ dimethyl amine oxide | 6.8% | 7.5% | 6.8% | — | — |
| Cocoamidopropyl betaine | — | — | — | 6.8% | 7.5% |
| Ethoxylated polyethyleneimine³ | 1% | 0.5% | 0.3 | 0.5% | 0.5% |
| EO-PO-EO copolymer of formula (I)⁴ | 1% | 1.5% | — | 1% | — |
| EO-PO-EO copolymer of formula (I)⁵ | — | — | 0.8% | — | — |
| EO-PO-EO copolymer of formula (I)⁶ | — | — | — | — | 1% |
| Ethanol | 2.0% | 1.0% | 2.0% | 2.0% | 2.0% |
| NaCl | 0.7% | 1.0% | 1.0% | 0.7% | 0.7% |
| Polypropyleneglycol (MW2000) | 0.7% | — | 0.7% | 0.7% | 0.7% |
| Water + Minor ingredients (perfume, | Balance | Balance | Balance | Balance | Balance |
| dye, preservatives) | to 100% | to 100% | to 100% | to 100% | to 100% |
| pH (at 10% product concentration in | 9.0 | 9.0 | 9.0 | 9.0 | 9.0 |
| demineralized water - with NaOH | | | | | |
| trimming) | | | | | |

⁴ EO₁₃-PO₃₀-EO₁₃, Tergitol ® L64E, supplied by DOW
⁵ EO11-PO₂₁-EO₁₁, Pluronic ® L44, supplied by BASF
⁶ EO₅-PO₁₉-EO₅, Pluronic ® PE4300, supplied by BASF

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid hand dishwashing cleaning composition comprising:
a. from about 5% to about 50% by weight of the total composition of a surfactant system; and
b. from about 0.1% to about 5.0% by weight of the total composition of at least one ethyleneoxide (EO)-propyleneoxide (PO)-ethyleneoxide (EO) triblock co-polymer of Formula (I):
(EO)x-(PO)y-(EO)x (I)
wherein:
each x is independently a number average between about 3 and about 50; and
y is a number average between about 5 and about 60; and
c. from about 0.05% to about 2.0% by weight of the total composition of an ethoxylated polyalkyleneimine and mixtures thereof, wherein the ethoxylated polyalkyleneimine comprises no further alkoxylation and wherein the ethoxylated polyalkyleneimine comprises a polyethyleneimine backbone having a weight average molecular weight of less than about 1500 g/mol.

2. The composition according to claim 1, wherein the composition comprises from about 0.25% to about 3.0%, by weight of the total composition of the triblock co-polymer.

3. The composition according to claim 1, wherein the composition comprises from about 0.5% to about 2.0%, by weight of the total composition of the triblock co-polymer.

4. The composition according to claim 1 wherein each x is independently a number average between about 5 and about 25; and y is a number average between about 10 and about 40.

5. The composition according to claim 4 wherein each x is independently a number average between about 10 and about 15; and y is a number average between about 25 and about 35.

6. The composition according to claim 1 wherein the triblock co-polymer has a ratio of y to each x of from about 0.8:1 to about 5:1.

7. The composition according to claim 1 wherein the triblock co-polymer has an average weight percentage of total EO of between about 30% and about 50% by weight of the tri-block co-polymer.

8. The composition according to claim 1, wherein the liquid hand dishwashing composition comprises from about 0.05% to about 2.5% by weight of the liquid detergent composition of the ethoxylated polyalkyleneimine.

9. The composition according to claim 1 wherein the ethoxylated polyalkyleneimine comprises:
a. a polyethyleneimine backbone having a weight average molecular weight of between about 200 g/mol and about 1500 g/mol;
b. an average of about 5 to about 40 ethoxy units per ethoxylation chain;
c. the ethoxylated polyethyleneimine has a total weight average molecular weight of from about 5000 g/mol to about 20000 g/mol;
d. wherein the terminal ethoxy moiety of the ethoxylation modification is capped with hydrogen, a C1-C4 alkyl or mixtures thereof; and
e. the degree of permanent quaternization being from about 0% to about 30% of the polyethyleneimine backbone nitrogen atoms;
wherein the ethoxylated polyethyleneimine does not comprise any other alkoxylations other than ethoxylation.

10. The composition according to claim 9 wherein the ethoxylated polyalkyleneimine comprises:
a. a polyethyleneimine backbone having a weight average molecular weight of between about 300 g/mol and about 1000 g/mol;
b. an average of about 10 to about 30 ethoxy units per ethoxylation chain;
c. the ethoxylated polyethyleneimine has a total weight average molecular weight of from about 7500 g/mol to about 17500 g/mol;
d. wherein the terminal ethoxy moiety of the ethoxylation modification is capped with hydrogen or methyl or mixtures thereof; and
e. the degree of permanent quaternization being from about 0% to about 10% of the polyethyleneimine backbone nitrogen atoms.

11. The composition according to claim 1, wherein the liquid hand dishwashing cleaning composition comprising from about 8% to about 45%, by weight of the total composition of the surfactant system.

12. The composition according to claim 1, wherein the surfactant system comprises anionic surfactant and a co-surfactant selected from the group consisting of an amphoteric surfactant, a zwitterionic surfactant and mixtures thereof.

13. The composition according to claim 12, wherein the anionic surfactant comprises alkyl sulphated anionic surfactant selected from the group consisting of: alkyl sulphate, alkyl alkoxy sulphate, and mixtures thereof.

14. The composition according to claim 13, wherein the alkyl sulphated anionic surfactant has an average alkyl chain length of from about 8 to about 18 carbon atoms.

15. The composition according to claim 13, wherein the alkyl sulphated anionic surfactant has an average degree of alkoxylation, of less than about 5.

16. The composition according to claim 15, wherein the alkyl sulphated anionic surfactant has an average degree of alkoxylation, of from 0.5 to 2.0.

17. The composition according to claim 13, wherein the alkyl sulphated anionic surfactant has a weight average degree of branching of more than about 10%.

18. The composition according to claim 12, wherein the co-surfactant is an amphoteric surfactant selected from amine oxide surfactant, wherein the amine oxide surfactant is selected from the group consisting of: alkyl dimethyl amine oxide, alkyl amido propyl dimethyl amine oxide, and mixtures thereof.

19. The composition according to claim 12, wherein the weight ratio of the anionic surfactant to the co-surfactant is from about 1:1 to about 8:1.

20. A method of manually washing dishware comprising the steps of: delivering a composition according to claim 1 to a volume of water to form a wash solution and immersing the dishware in the solution, wherein the wash solution is at a temperature of greater than about 30° C.
